(19) United States
(12) Patent Application Publication
(10) Pub. No.: US 2023/0006914 A1
(43) Pub. Date: Jan. 5, 2023

(54) ROUTING DEVICE AND METHOD THEREOF

(71) Applicants: HYUNDAI MOTOR COMPANY, SEOUL (KR); KIA CORPORATION, SEOUL (KR); KYUNGSHIN CORP., INCHEON (KR)

(72) Inventors: Jeong Min Kim, Suwon-si (KR); Hyun Sock Yi, Incheon (KR)

(21) Appl. No.: 17/579,894

(22) Filed: Jan. 20, 2022

(30) Foreign Application Priority Data
Jun. 30, 2021 (KR) 10-2021-0086048

(51) Int. Cl. H04L 45/02; H04L 45/00

(52) U.S. Cl. CPC H04L 45/02; H04L 45/72

(57) ABSTRACT

A routing device and a method thereof are provided. The routing device includes a network interface that assists in connecting to at least two source networks and a destination network, a processor connected to the network interface, and a non-transitory storage storing instructions executed by the processor. The processor routes only one of messages received from the at least two source networks to the destination network based on message reception states from the at least two source networks.

### CROSS REFERENCE TO RELATED APPLICATIONS

This application claims the benefit of priority to Korean Patent Application No. 10-2021-0086048, filed in the Korean Intellectual Property Office on Jun. 30, 2021, the entire contents of which are incorporated herein by reference.

### TECHNICAL FIELD

The present disclosure relates to a routing device and a method thereof.

### BACKGROUND

In general, in a direct routing scheme, a central gateway electronic control unit (ECU) routes all received messages to a destination network, irrespective of information, for example, an identification (ID), data, and the like, in a message received from a source network. Recently, an autonomous vehicle transmits a message having the same data as data transmitted over a main network using an auxiliary network to ensure communication redundancy. Due to this, the central gateway ECU routes messages, each of which has the same data, which are received from the main network and the auxiliary network, to the destination network. Thus, there is an unnecessary increase in bus load rate on the destination network.

### SUMMARY

The present disclosure has been made to solve the above-mentioned problems occurring in the prior art while advantages achieved by the prior art are maintained intact.

An aspect of the present disclosure provides a routing device for routing only one of received message to a destination network, when receiving the messages, each of which includes the same data, from a plurality of source networks, and a method thereof.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a routing device may include a network interface that assists in connecting to at least two source networks and a destination network, a processor connected to the network interface, and a non-transitory storage storing instructions executed by the processor. The processor may route only one of messages received from the at least two source networks to the destination network based on message reception states from the at least two source networks.

The processor may identify whether a message is normally received from each of the at least two source networks within a predetermined reference time.

The processor may route a first message, received from a first source network among the at least two source networks, to the destination network, when all the messages are normally received from the at least two source networks.

The processor may route a second message, received from a second source network among the at least two source networks, to the destination network, when the first message is not normally received from the first source network.

The processor may identify whether the second message is being routed to the destination network, when the first message is normally received again from the first source network.

The processor may stop routing the second message to the destination network, while the second message is being routed to the destination network, and may route the first message, received from the first source network, to the destination network.

The processor may maintain the routing of the second message to the destination network to identify whether the second message is normally received from the second source network, while the second message is being routed to the destination network, may stop routing the second message to the destination network, when the second message is not normally received, and may route the first message, received from the first source network, to the destination network.

The processor may route the first message, received from the first source network, to the destination network, when the second message is not being routed to the destination network.

The processor may selectively route one of the messages received from the at least two source networks, when an event occurs.

The event may be defined as a change in local input or communication input, which is input to the routing device.

According to another aspect of the present disclosure, a routing method may include identifying message reception states of at least two source networks and routing one of messages received from the at least two source networks to a destination network based on the message reception states.

The identifying of the message reception states may include identifying whether a message is normally received from each of the at least two source networks within a predetermined reference time.

The routing may include routing a first message, received from a first source network among the at least two source networks, to the destination network, when all the messages are normally received from the at least two source networks.

The routing may further include identifying whether a second message is normally received from a second source network among the at least two source networks, when the first message is not normally received from the first source network, and routing the second message to the destination network, when the second message is normally received.

The routing may further include stopping routing the second message to the destination network, when the first message is normally received from the first source network, and routing the first message to the destination network.

The routing may further include maintaining the routing of the second message to the destination network, when the first message is normally received again from the first source network.

The routing may further include identifying whether the second message is normally received from the second source network and routing the first message to the destination network, when the second message is not normally received.

The routing may include selectively routing one of the messages received from the at least two source networks, when an event occurs.

The event may be defined as a change in local input or communication input, which is input to a routing device.

### BRIEF DESCRIPTION OF THE FIGURES

The above and other objects, features and advantages of the present disclosure will be more apparent from the following detailed description taken in conjunction with the accompanying drawings:

FIG. 1 is a block diagram illustrating a configuration of a system in a vehicle according to embodiments of the present disclosure;

FIG. 2 is a drawing illustrating routing control according to a source network state according to embodiments of the present disclosure;

FIG. 3 is a block diagram illustrating a configuration of a routing device according to embodiments of the present disclosure;

FIG. 4 is a flowchart illustrating a routing method according to an embodiment of the present disclosure; and

FIG. 5 is a flowchart illustrating a routing method according to another embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

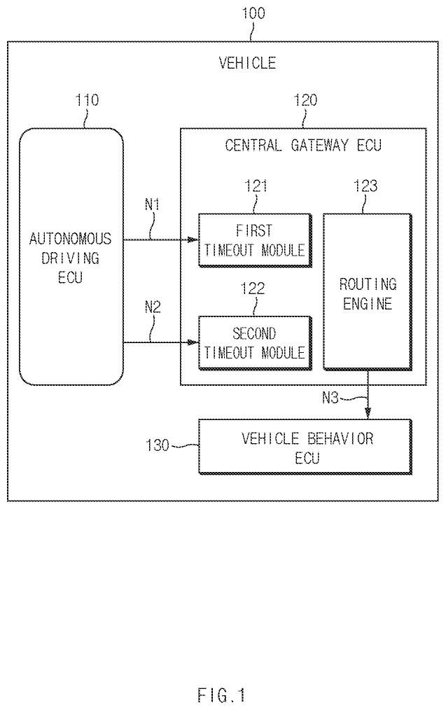

FIG. 1 is a block diagram illustrating a configuration of a system in a vehicle according to embodiments of the present disclosure.

Referring to FIG. 1, a vehicle 100 may include an autonomous driving ECU 110, a central gateway ECU 120, and a vehicle behavior ECU 130. The ECU 110, 120, or 130 may include at least one processor and a memory storing instructions executed by the at least one processor.

The autonomous driving ECU 110 may recognize a driving environment and/or a vehicle state by means of various sensors and/or other ECUs loaded into the vehicle, may plan a driving route based on the recognized driving environment, the recognized vehicle state, and/or the like to control autonomous driving of the vehicle. The autonomous driving ECU 110 may generate a message including data (e.g., a control command, risk information, driving environment information, vehicle state information, and/or the like) for autonomous driving control. The autonomous driving ECU 110 may transmit the generated message over a first network N1 or a second network N2. Herein, the autonomous driving ECU 110 may use the first network N1 as a main network and may use the second network N2 as an auxiliary network. The autonomous driving ECU 110 may transmit a message based on a predetermined transmission period.

The central gateway ECU 120 may be a routing device which directly performs routing, for communication inside and outside the vehicle. The central gateway ECU 120 may fail to operate, when there is no need to directly perform a routing function, for example, a state where there is no need to use a destination network or a state where power is not supplied. The central gateway ECU 120 may receive a message from a source network, that is, the first network N1 and the second network N2. The central gateway ECU 120 may route the received message to a third network N3 which is the destination network. Such a central gateway ECU 120 may include a first timeout module 121, a second timeout module 122, a routing engine 123, and the like.

The first timeout module 121 may determine whether the message received over the first network N1 is normally received. The first timeout module 121 may count a time when a message is not received from the first network N1, that is, a message non-reception time. The first timeout module 121 may compare the counted message non-reception time with a predetermined first reference time. When the counted message non-reception time is greater than or equal to the predetermined first reference time, the first timeout module 121 may determine a first network reception state as a timeout state (or a non-reception state). When the counted message non-reception time is less than the predetermined first reference time, the first timeout module 121 may determine the first network reception state as a normal state (or a normal reception state).

The second timeout module 122 may determine whether the message received over the second network N2 is normally received. The second timeout module 122 may count a time when a message is not received from the second network N2. The second timeout module 122 may identify whether the counted message non-reception time is greater than or equal to a predetermined second reference time. When the counted message non-reception time is greater than or equal to the second reference time, the second timeout module 122 may determine a second network reception state as a timeout state. When the counted message non-reception time is less than the second reference time, the second timeout module 122 may determine the second network reception state as a normal state.

The first reference time and the second reference time may be set to be identical to each other or may be set to be different from each other. The first reference time may be set to three times a message reception period using the first network N1, and the second reference time may be set to three times a message reception period using the second network N2.

The first timeout module 121 and the second timeout module 122 may operate when messages received over the first network N1 and the second network N2 are messages which are transmitted on a periodic basis and may fail to operate when the messages received over the first network N1 and the second network N2 are transmitted in an event trigger scheme.

By controlling optional direct routing, the routing engine 123 may receive a message from the first network N1 and/or the second network N2 and may route the received message to the third network N3. The routing engine 123 may identify a first network reception state and a second network reception state from the first timeout module 121 and the second timeout module 122. When both the first network reception state and the second network reception state are a normal state, the routing engine 123 may route a message, received from one of the first network N1 or the second network N2, to the third network N3. When the first network reception state is the timeout state, the routing engine 123 may route a message, received from the second network N2, to the third network N3. When the second network reception state is the timeout state, the routing engine 123 may route a message, received from the first network N1, to the third network N3.

The vehicle behavior ECU 130 may receive a message, transmitted from the central gateway ECU 120, over the third network N3. The vehicle behavior ECU 130 may control a behavior of the vehicle based on the information included in the message. The vehicle behavior ECU 130 may include controllers having functions of controlling steering, braking, and/or acceleration and deceleration of the vehicle.

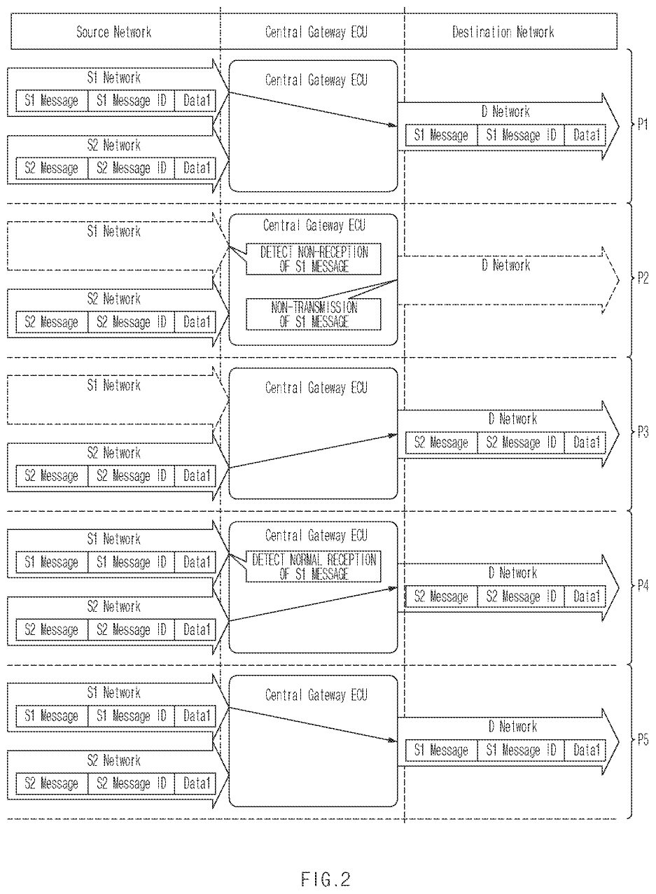

FIG. 2 is a drawing illustrating routing control according to a source network state according to embodiments of the present disclosure.

In the present embodiment, a description will be given of a control method capable of routing only one message to a destination network to reduce a bus load rate of the destination network, when receiving messages, each of which has the same data, from two source networks.

First of all, in a state P1 where messages are normally received over two source networks, that is, an S1 network and an S2 network, a central gateway ECU 120 may respectively receive an S1 message and an S2 message over the S1 network and the S2 network. A controller which transmits the S1 message and the S2 message may transmit the messages on a periodic basis. When pieces of data Datal respectively included in the S1 message and the S2 message respectively received over the S1 network and the S2 network are the same as each other, the central gateway ECU 120 may route the S1 message, received from the S1 network, to a D network which is a destination network.

Next, in a state P2 where a message is not received over the S1 network, the central gateway ECU 120 may fail to perform routing. The central gateway ECU 120 may identify whether a state where the S1 message is not received over the S1 network is maintained during a first reference time. When the state where the S1 message is not received over the S1 network is maintained during the first reference time, the central gateway ECU 120 may finally determine an S1 network message reception state (an S1 network reception state) as a timeout state.

In a state P3 where the S2 message is normally received over the S2 network, after determining the S1 network reception state as the timeout state in P2, the central gateway ECU 120 may receive the S2 message over the S2 network and may route the S2 message to the D network. Thus, controllers in the vehicle, which receive the S1 message or the S2 message over the D network, may receive the same data.

In a state S4 capable of normally receiving a message again over the S1 network while routing the S2 message received from the S2 network, when detecting that it is able to normally receive the message again over the S1 network, the central gateway ECU 120 may change the S1 network reception state from the timeout state to a normal state. The central gateway ECU 120 may stop routing the S2 message received from the S2 network.

After the S1 network reception state is determined as the normal state in P4, in P5, the central gateway ECU 120 may receive the S1 message over the S1 network and may route the S1 message to the D network. In other words, the central gateway ECU 120 may return to the state P1.

The above-mentioned embodiment describes that the central gateway ECU 120 selectively routes one of the S1 message or the S2 message to the D network based on the message reception state over the S1 network and the S2 network, but not limited thereto. When an event such as a change in local input or communication input occurs, the central gateway ECU 120 may selectively route one of messages received from the S1 network and the S2 network to the D network. At this time, the messages received from the S1 network and the S2 network may include the same data or different data. The local input may be input from another controller connected in hardware with the central gateway ECU 120. When receiving an active signal from the other controller, the central gateway ECU 120 may perform an optional direct routing function. When receiving an inactive signal from the other controller, the central gateway ECU 120 may stop the optional direct routing function. The communication input may define activation or deactivation of a communication signal. Because the central gateway ECU 120 is connected with a plurality of CAN networks, it may perform or stop the optional direct routing function depending on activation or deactivation of a CAN communication signal.

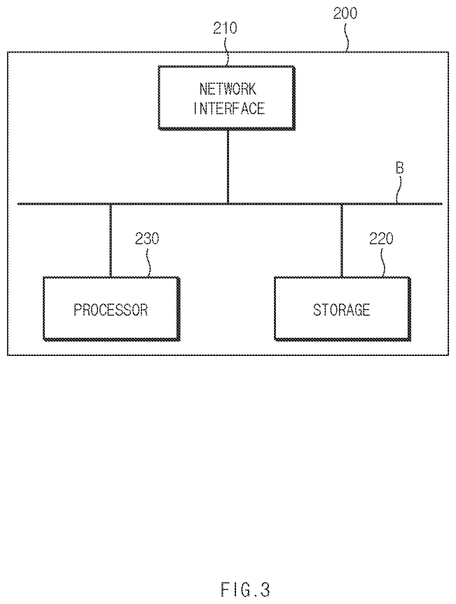

FIG. 3 is a block diagram illustrating a configuration of a routing device according to embodiments of the present disclosure.

Referring to FIG. 3, a routing device 200 may be a central gateway ECU which performs optional direct routing. The routing device 200 may include a network interface 210, a storage 220, a processor 230, and the like, which are connected with each other through a bus B.

The network interface 210 may assist the routing device 200 to be connected to networks inside and outside of the vehicle. In other words, the routing device 200 in the vehicle may be connected to a source network, a destination network, and the like using the network interface 210. The networks inside and outside the vehicle may be implemented with a communication technology such as wireless Internet, mobile communication, and/or vehicle communication (e.g., vehicle to everything (V2X)). Wireless LAN (WLAN) (Wi-Fi), wireless broadband (Wibro), world interoperability for microwave access (WiMAX), and/or the like may be used as the Internet technology. Code division multiple access (CDMA), global system for mobile communication (GSM), long term evolution (LTE), LTE-advanced, and/or the like may be used as the mobile communication technology. Vehicle to vehicle (V2V) communication, vehicle to infrastructure (V2I) communication, vehicle-to-nomadic devices (V2N) communication, in-vehicle network (IVN) communication, and/or the like may be applied as the V2X communication technology.

The storage 220 may store a software module, for example, a first timeout module, a second timeout module, a routing engine, and/or the like. The storage 220 may store input data, output data, and/or the like according to an operation of the processor 230. The storage 220 may be a non-transitory storage medium which stores instructions executed by the processor 230. The storage 220 may be implemented as at least one of storage media (recording media) such as a flash memory, a hard disk, a solid state disk (SSD), a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), or a register.

The processor 230 may receive messages from at least two source networks. The processor 230 may identify information, for example, an ID, data, and/or the like, which are/is included in each of the received messages. In other words, the processor 230 may identify whether pieces of information included in the received messages are the same as each other. The processor 230 may determine whether pieces of information included in the received message are the same as each other using a message analysis technology which is previously known. When the pieces of information included in the received messages are the same as each other, the processor 230 may route only one of the received messages to a destination network.

Hereinafter, an optional direct routing control process will be described in detail as an example in which an autonomous driving ECU 110 respectively transmits a first message and a second message, each of which includes the same data, to a first source network and a source network at a predetermined transmission period.

The processor 230 may identify whether the first message and the second message are normally received from the first source network and the second source network. When receiving the first message and the second message within a predetermined time, the processor 230 may set a first source network reception state and a second source network reception state to a normal state. When receiving both the first message and the second message, the processor 230 may selectively route only the first message to the destination network.

When the first message is not received from the first source network during a first reference time, the processor 230 may identify whether the second message is received from the second source network within a second reference time. When the second message is received from the second source network within the second reference time, the processor 230 may route the second message to the destination network.

When the first message is received again from the first source network while routing the second message to the destination network, the processor 230 may stop routing the second message, received from the second source network, to the destination network and may route the first message to the destination network.

As another example, although the first message is received again from the first source network, the processor 230 may continue routing the second message, received from the second source network, to the destination network. The processor 230 may maintain the routing of the second message and may identify whether the second message is received from the second source network within the second reference time. When the second message is not received from the second source network during the second reference time, the processor 230 may stop routing the second message and may route the first message, received from the first source network, to the destination network.

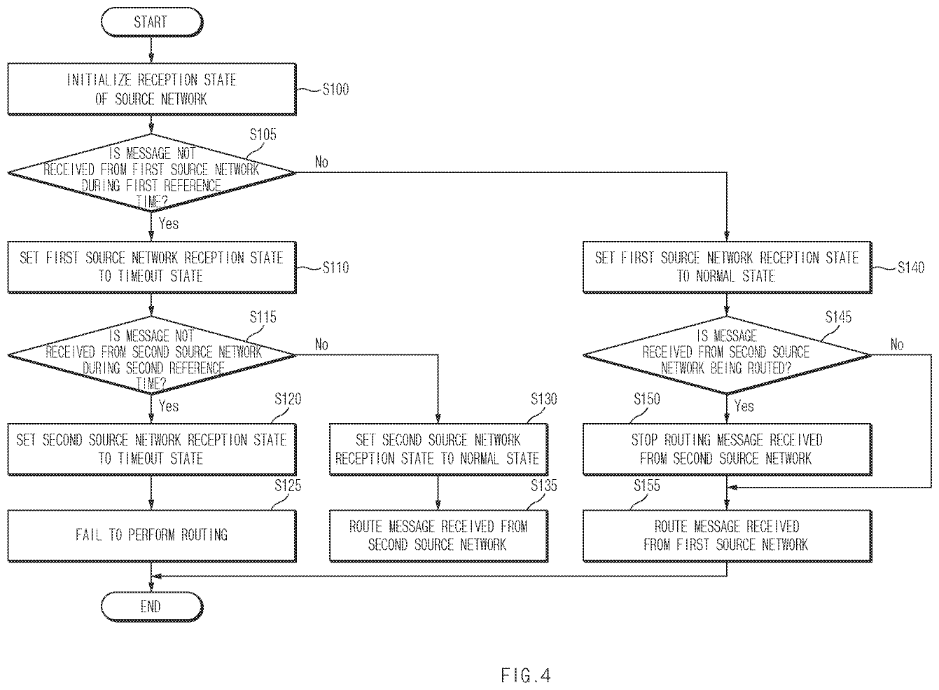

FIG. 4 is a flowchart illustrating a routing method according to an embodiment of the present disclosure.

First of all, in S100, a processor 230 of FIG. 3 may initialize reception states of at least two source networks. The processor 230 may set each of message reception states of a first source network and a second source network, which are source networks, to an initial value (e.g., a normal state). The processor 230 may store the initialized message reception state of the source network in a storage 220 of FIG. 3.

In S105, the processor 230 may identify whether a message is not received from the first source network during a first reference time. The processor 230 may count a time while a first message is not received over the first source network. The processor 230 may compare the counted message non-reception time with the first reference time.

When the message is not received from the first source network during the first reference time, in S110, the processor 230 may set a message reception state over the first source network (a first source network reception state) to a timeout state. When the counted message non-reception time is greater than or equal to the first reference time, the processor 230 may determine the first source network reception state as the timeout state. When the first source network reception state is determined as the timeout state, the processor 230 may update the previous first source network reception state to the timeout state.

In S115, the processor 230 may identify whether a message is not received from the second source network during a second reference time. The processor 230 may count a time while a second message is not received over the second source network. The processor 230 may compare the counted message non-reception time with the second reference time. The processor 230 may determine a second source network reception state based on the compared result.

When the message is not received from the second source network during the second reference time, in S120, the processor 230 may set the second source network reception state to the timeout state. When the counted message non-reception time is greater than or equal to the second reference time, the processor 230 may determine the second source network reception state as the timeout state. The processor 230 may change and set the previous second source network reception state to the timeout state based on the determined result.

Next, in S125, the processor 230 may fail to perform routing. In other words, the processor 230 may fail to perform routing, when it is unable to receive the message from the first source network and the second source network.

When the message is received from the second source network within the second reference time in S115, in S130, the processor 230 may set the second source network reception state to a normal state.

In S135, the processor 230 may route the message, received from the second source network, to a destination network. The processor 230 may route a second message, received from the second source network, to the destination network.

When the message is received from the first source network within the first reference time in S105, in S140, the processor 230 may set the first source network reception state to the normal state.

In S145, the processor 230 may identify whether the message received from the second source network is being routed to the destination network. The processor 230 may receive the second message from the second source network and may route the second message to the destination network.

When the message received from the second source network is being routed to the destination network, in S150, the processor 230 may stop routing the message received from the second source network.

In S155, the processor 230 may route the message, received from the first source network, to the destination network. The processor 230 may receive the first message from the first source network and may route the first message to the destination network.

When the message received from the second source network is not being routed to the destination network in S145, in S155, the processor 230 may route the message, received from the first source network, to the destination network.

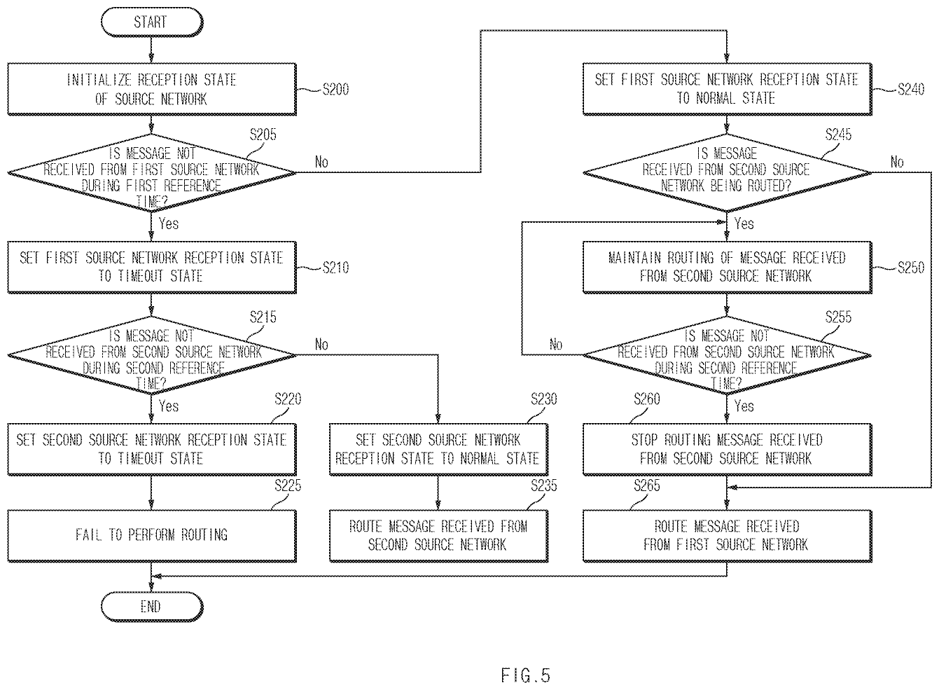

FIG. 5 is a flowchart illustrating a routing method according to another embodiment of the present disclosure.

First of all, in S200, a processor 230 of FIG. 3 may initialize reception states of at least two source networks. The processor 230 may set each of message reception states of a first source network and a second source network, which are source networks, to an initial value (e.g., a normal state). The processor 230 may store the initialized message reception state of the source network in a storage 220 of FIG. 3.

In S205, the processor 230 may identify whether a message is not received from the first source network during a first reference time. The processor 230 may count a time while a first message is not received over the first source network. The processor 230 may compare the counted message non-reception time with the first reference time.

When the message is not received from the first source network during the first reference time, in S210, the processor 230 may set a message reception state over the first source network (a first source network reception state) to a timeout state. When the counted message non-reception time is greater than or equal to the first reference time, the processor 230 may determine the first source network reception state as the timeout state. When the first source network reception state is determined as the timeout state, the processor 230 may update the previous first source network reception state to the timeout state.

In S215, the processor 230 may identify whether a message is not received from the second source network during a second reference time. The processor 230 may count a time while a second message is not received over the second source network. The processor 230 may compare the counted message non-reception time with the second reference time. The processor 230 may determine a second source network reception state based on the compared result.

When the message is not received from the second source network during the second reference time, in S220, the processor 230 may set the second source network reception state to the timeout state. When the counted message non-reception time is greater than or equal to the second reference time, the processor 230 may determine the second source network reception state as the timeout state. The processor 230 may change and set the previous second source network reception state to the timeout state based on the determined result.

Next, in S225, the processor 230 may fail to perform routing. In other words, the processor 230 may fail to perform routing, when it is unable to receive the message from the first source network and the second source network.

When the message is received from the second source network within the second reference time in S215, in S230, the processor 230 may set the second source network reception state to a normal state.

In S235, the processor 230 may route the message, received from the second source network, to a destination network. The processor 230 may route a second message, received from the second source network, to the destination network.

When the message is received from the first source network within the first reference time in S205, in S240, the processor 230 may set the first source network reception state to the normal state.

In S245, the processor 230 may identify whether the message received from the second source network is being routed to the destination network. The processor 230 may receive the second message from the second source network and may route the second message to the destination network.

When the message received from the second source network is being routed to the destination network, in S250, the processor 230 may maintain the routing of the message received from the second source network. When normally receiving the message from the second source network and routing the message to the destination network, the processor 230 may maintain the routing operation.

In S255, the processor 230 may identify whether a message is not received from the second source network during a second reference time. The processor 230 may detect (recognize) a state where a message is not received over the second source network.

When the message is not received from the second source network during the second reference time, in S260, the processor 230 may stop routing the message received from the second source network. At this time, the processor 230 may change and set the previous second source network reception state to the timeout state.

In S265, the processor 230 may route the message, received from the first source network, to the destination network. The processor 230 may receive the first message from the first source network and may route the first message to the destination network.

When the message received from the second source network is not being routed to the destination network in S245, in S265, the processor 230 may route the message, received from the first source network, to the destination network.

When the message is normally received from the second source network within the second reference time in S255, the processor 230 may maintain the routing of the message received from the second source network.

According to embodiments of the present disclosure, the routing device may route only one of received messages to a destination network, when receiving the messages, each of which includes the same data, from a plurality of source networks, thus reducing a bus load rate of the destination network. In addition, vehicle functions may be performed in a suitable time, because a delay does not occur in receiving necessary information, when controllers for a vehicle control the vehicle functions.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

1. A routing device, comprising:
a network interface configured to assist in connecting to at least two source networks and a destination network;
a processor connected to the network interface; and
a non-transitory storage configured to store instructions executed by the processor;
wherein the processor routes only one of a plurality of messages received from the at least two source networks to the destination network based on message reception states from the at least two source networks.

2. The routing device of claim 1, wherein the processor identifies whether a message is normally received from each of the at least two source networks within a predetermined reference time.

3. The routing device of claim 1, wherein the processor routes a first message, received from a first source network among the at least two source networks, to the destination network, when all the messages are normally received from the at least two source networks.

4. The routing device of claim 3, wherein when the first message is not normally received from the first source network, the processor routes a second message, received from a second source network among the at least two source networks, to the destination network.

5. The routing device of claim 4, wherein when the first message is normally received again from the first source network, the processor identifies whether the second message is being routed to the destination network.

6. The routing device of claim 5, wherein the processor stops routing the second message to the destination network, while the second message is being routed to the destination network, and routes the first message, received from the first source network, to the destination network.

7. The routing device of claim 5, wherein when the second message is not normally received, the processor maintains the routing of the second message to the destination network to identify whether the second message is normally received from the second source network, while the second message is being routed to the destination network, stops routing the second message to the destination network, and routes the first message, received from the first source network, to the destination network.

8. The routing device of claim 5, wherein when the second message is not being routed to the destination network, the processor routes the first message, received from the first source network, to the destination network.

9. The routing device of claim 1, wherein the processor selectively routes one of the plurality of messages received from the at least two source networks when an event occurs.

10. The routing device of claim 9, wherein the event is defined as a change in local input or communication input, which is input to the routing device.

11. A routing method, comprising:
identifying, via processor, message reception states of at least two source networks; and
routing, via the processor, one of a plurality of messages received from the at least two source networks to a destination network based on the message reception states.

12. The routing method of claim 11, wherein the identifying of the message reception states includes:
identifying whether a message is normally received from each of the at least two source networks within a predetermined reference time.

13. The routing method of claim 11, wherein the routing includes:
routing a first message received from a first source network among the at least two source networks to the destination network, when all the messages are normally received from the at least two source networks.

14. The routing method of claim 13, wherein the routing further includes:
identifying whether a second message is normally received from a second source network among the at least two source networks when the first message is not normally received from the first source network; and
routing the second message to the destination network when the second message is normally received.

15. The routing method of claim 14, wherein the routing further includes:
stopping routing the second message to the destination network when the first message is normally received from the first source network; and
routing the first message to the destination network.

16. The routing method of claim 14, wherein the routing further includes:
maintaining the routing of the second message to the destination network when the first message is normally received again from the first source network.

17. The routing method of claim 14, wherein the routing further includes:
identifying whether the second message is normally received from the second source network; and
routing the first message to the destination network when the second message is not normally received.

18. The routing method of claim 11, wherein the routing includes:
selectively routing one of the plurality of messages received from the at least two source networks when an event occurs.

19. The routing method of claim 18, wherein the event is defined as a change in local input or communication input, which is input to a routing device.
